(19) United States
(12) Patent Application Publication
(10) Pub. No.: US 2007/0220763 A1
(43) Pub. Date: Sep. 27, 2007

(54) Compass ornament

(76) Inventor: Jui-An Tsai, Tao-Yuan City (TW)

Correspondence Address: TROXELL LAW OFFICE PLLC, SUITE 1404, 5205 LEESBURG PIKE, FALLS CHURCH, VA, 22041, US

(21) Appl. No.: 11/385,803

(22) Filed: Mar. 22, 2006

(51) Int. Cl. G01C 17/00

(52) U.S. Cl. 33/355 R

(57) ABSTRACT

A compass ornament includes a base and a rotatable balancing stand disposed on the base. A seat is disposed on top of the base as a rotation seat of the balancing stand. The balancing stand is a symmetrical rack symmetrical to a rotation axis and having at least a rack passing through the rotation axis. A shaft arranged on the center point of the rack is connected with and supported by a seat on the base to form a pivot point for rotation. Each of the two sides of the balancing stand is disposed symmetrically with a magnetic block with the same weight so that the balancing stand is in a balance status while the northern and southern poles of the two magnetic blocks are in the same direction. An azimuth scale is disposed on the balancing stand and is corresponding to the southern and northern magnetic poles of the magnetic blocks for indicating directions and showing detailed angles. Thus users can freely rotate the balancing stand that aligns with the earth's magnetic field and then points directions as a compass while stops.

### BACKGROUND OF THE INVENTION

The present invention relates to a compass ornament, especially to a compass ornament that finds earth's magnetic field for pointing directions and rotates for visual effect.

The compass available now is a small disc enclosed in a housing. A transparent window is on top surface for users to observe the direction while a shaft with a magnetic needle having the N and S poles is arranged inside the compass so that the magnetic needle is able to find earth's magnetic field and point in a northerly or southerly direction. However, conventional compasses only indicate directions with a small needle inside a disc.

It has no decorative effect.

### SUMMARY OF THE INVENTION

Therefore it is a primary object of the present invention to provide a compass ornament that includes a rotatable balancing stand disposed on a base. The balancing stand is a rack symmetrical to a rotation axis with a shaft in the center point for supporting the balancing stand on a seat on surface of the base, as a pivot point for rotation. Magnetic blocks with the same weight and same direction of magnetic pole are installed on two sides of the balancing stand so as to make the balancing stand in a balanced status. Moreover, the balancing stand is labeled with scale and the detailed angle of each direction, corresponding to the magnetic pole of magnetic block. In usage, the balancing stand aligns with earth's magnetic field so as to indicate directions and users can drive or rotate the balancing stand randomly.

It is another object of the present invention to provide a compass ornament whose balancing stand and the base are design to various styles and the balancing stand is rotatable for catching viewers' attention.

### BRIEF DESCRIPTION OF THE DRAWINGS

FIG. 1 is an explosive view of an embodiment in accordance with the present invention;

FIG. 2 is a perspective view of the embodiment in FIG. 1 according to the present invention;

FIG. 3 is a cross-sectional view of the embodiment in FIG. 2;

FIG. 4 is an explosive view of another embodiment in accordance with the present invention;

FIG. 5 is a perspective view of the embodiment in FIG. 4 according to the present invention;

FIG. 6 is a cross-sectional view of the embodiment in FIG. 5.

### DETAILED DESCRIPTION OF THE PREFFERED

### EMBODIMENT

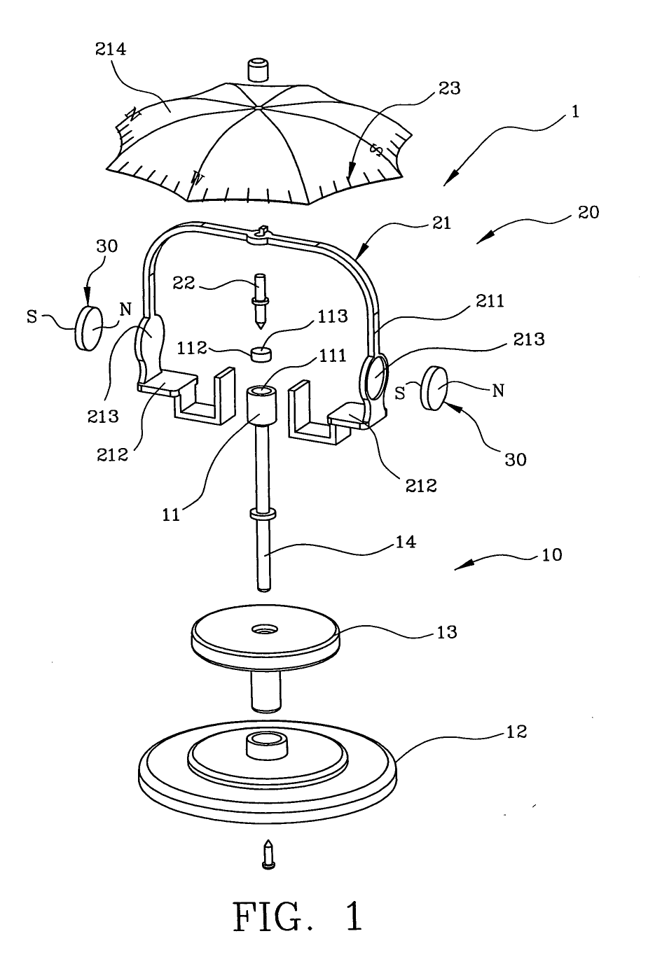

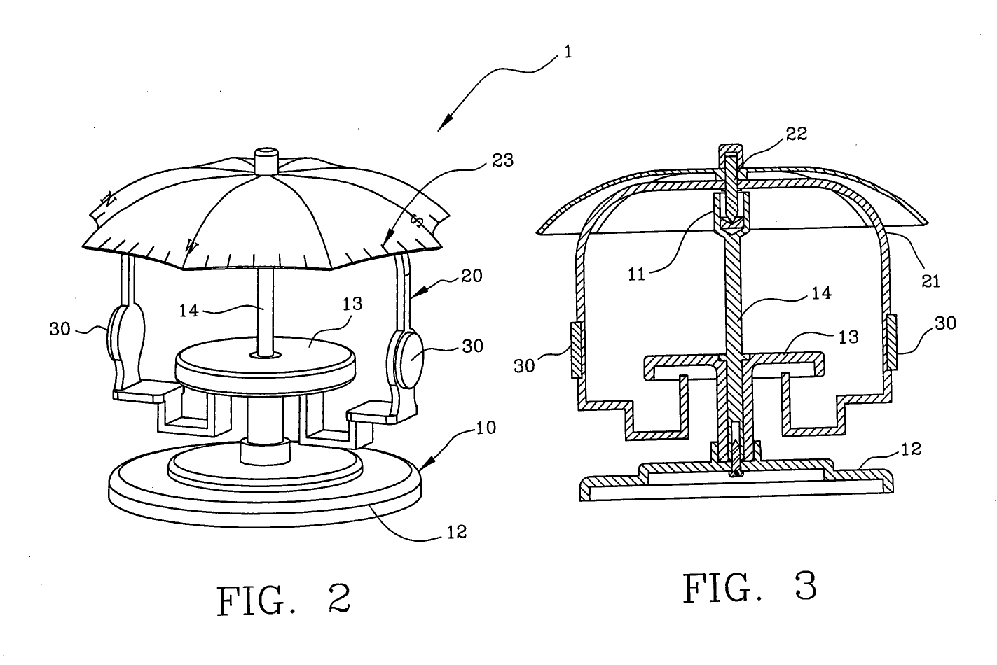

Refer from FIG. 1 to FIG. 3, a compass ornament 1 in accordance with the present invention consists of a base 10 and a rotatable balancing stand 20 disposed on the base 10. The base 10 is a body that can be set on a plane stably and a seat 11 is disposed thereon as a rotation seat of the balancing stand 20. The balancing stand 20 rotatable over the base 10 is a symmetrical rack with a rotation axis. There is no limit on shape of the balancing stand 20 while the balancing stand 20 includes at least a C-shaped rack 21 passing through the rotation axis and a shaft 22 arranged on the center point of the rack 21 is connected with and supported by a seat 11 on the base 10 through friction so as to form a rotation axis of the C-shaped rack 21 (balancing stand 20). Each of the two sides of the C-shaped rack 21 is disposed symmetrically with a magnetic block 30 with the same weight and both the magnetic blocks 30 are on a diameter line of the rack 21 so that the C-shaped rack 21 (balancing stand 20) is in a balance status. Moreover, the Southern and Northern magnetic poles of the two magnetic blocks 30 are in the same direction so as to make the C-shaped rack 21 align itself accurately with earth's magnetic field, as shown in FIG. 1. Furthermore, an azimuth scale 23 is disposed on the balancing stand 20 and is corresponding to the Southern and Northern magnetic poles of the magnetic blocks 30 so as to point direction and show detailed angles while the balancing stand 20 stops rotating.

By the gravity of the magnetic blocks 30 on two sides as well as support by the shaft 22, the balancing stand 20 rotates freely on the base 10 while the magnetic blocks 30 are free to align with the earth's magnetic field for finding directions on the earth. Further the balancing stand 20 is driven and moving synchronously with the magnetic blocks 30 for pointing directions. In usage, the compass ornament 1 can be set on any position or users may rotate the balancing stand 20 for pleasure. While the balancing stand 20 stops rotating, the balancing stand 20 aligns with the earth's magnetic field and points directions.

There is no limitation on shapes of the base 10 and the balancing stand 20. As shown in FIG. 1, the base 10 is composed by a plate 12, a disc 13 and a central rod 14. The seat 11 is arranged on top of the central rod 14. Moreover, the seat 11 consists of a slot 111 with a base for spire 112 that is preferably made from abrasion resistant metal and forms a reverse conical surface for supporting 113. The balancing stand 20 includes a rack 21, as shown from FIG. 1 to FIG. 3, or two vertical cross bars 21 (not shown in figure). The rack 21 has a C-shaped rack 211 symmetrical to a rotation axis while the shaft 22 is set under the central point of the C-shaped rack 211. The shaft 22 having a spire 221 that is located on the reverse conical surface for supporting 113 of the base for spire 112 so as to be a pivot point for rotation of the rack 21 (balancing stand 20). While the tail end of two sides of the C-shaped rack 211 forms a chair-shaped part 212 symmetrically. A concave 213 is formed on upper part of the chair-shaped part 212 for accommodation of the magnetic blocks 30. An umbrella cap 214 is covered over the C-shaped rack 211 and the azimuth scale 23 is disposed on surface of the umbrella cap 214. In accordance with above structure, the base 10 and the balancing stand 20 forms a merry-go-round body with two peripherally spaced apart chair-shaped parts, as shown in FIG. 1 to FIG. 3, or with four peripherally spaced apart chair-shaped parts so as to enhance decorative effect of the compass ornament 1.

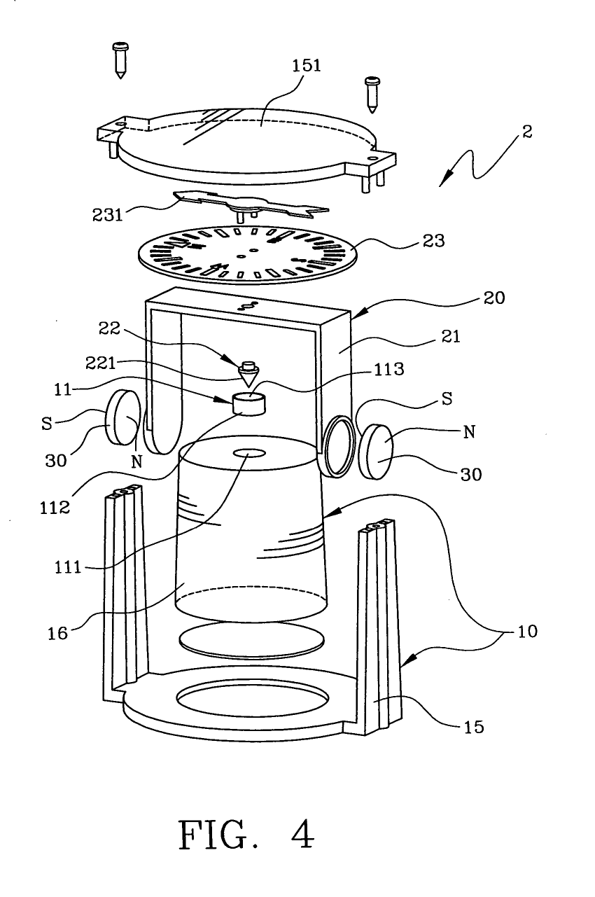

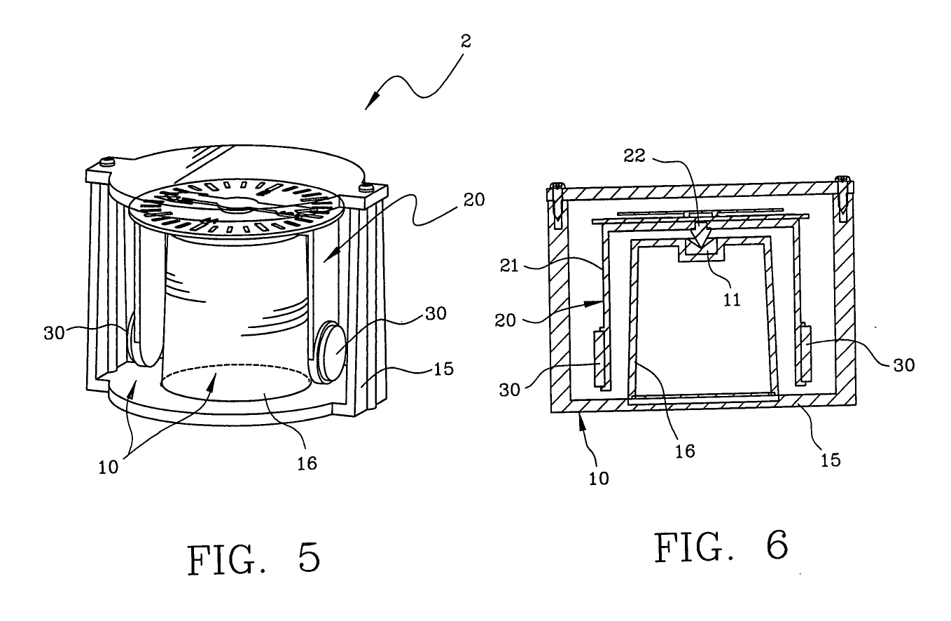

Refer from FIG. 4 to FIG. 6, a compass ornament 2 of the present invention has the same structure with the above embodiment, only shapes of the base 10 and the balancing stand 20 are different. For example, the base 10 of the compass ornament 2 is composed of a frame 15 and a decorative container 16. A transparent top cover 151 is on top of the frame 15 for observing downwards while the decorative container 16 is a housing set horizontally and is mounted inside the frame 15. There is no limitation on shape of the decorative container 16 but it is preferred to be a transparent body for accommodating and displaying various ornaments. The seat 11 is arranged on surface of the decorative container 16 as a rotation seat of the balancing stand 20. Moreover, the azimuth scale 23 corresponding to the Southern and Northern magnetic poles of the magnetic blocks 30 is disposed on the rack 21 (balancing stand 20). A needle 231 is fixed on the azimuth scale 23 so as to point directions obviously. Through the transparent top cover 151, users can see the azimuth scale 23 and the needle 231 so as to learn directions and angles, as shown in FIG. 5.

The decorative container 16 can be open-ended or close-ended container with transparent appearance and various ornaments such as liquid is filled inside the decorative container 16. The liquid ornament can be single-liquid or double-liquid type. The double-liquid type can be water, oil (such as mineral oil ) and floats on surface of the liquid. Moreover, a plurality of LED is disposed on bottom of the decorative container 16 so as to increase the visional effect.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A compass ornament comprising:
a base that is a body set on a plane stably and is disposed with a seat as a rotation seat of a balancing stand;
the balancing stand is a symmetrical rack with a rotation axis and having at least a C-shaped rack passing through the rotation axis; and a shaft arranged on the center point of the rack is connected with and supported by a seat on the base through friction so as to form a rotation axis of the balancing stand; each of the two sides of the balancing stand is disposed symmetrically with a magnetic block with the same weight so that the balancing stand is in a balance status while the northern and southern poles of the two magnetic blocks are in the same direction; an azimuth scale is disposed on the balancing stand and is corresponding to the southern and northern magnetic poles of the magnetic blocks so as to point direction and show detailed angles;
thereby the balancing stand rotates freely on the base and aligns accurately with earth's magnetic field for indicating directions by the magnetic blocks on two sides thereof.

2. The compass ornament as claimed in claim 1, wherein the seat having a slot as well as a base for spire that is disposed inside the slot, made from abrasion resistant metal and having a reverse conical surface for supporting.

3. The compass ornament as claimed in claim 1, wherein a spire is arranged on the shaft of the balancing stand and is located on the reverse conical surface for supporting of the base for spire so as to be a pivot point for rotation of the balancing stand.

4. The compass ornament as claimed in claim 1, wherein the base having a plate, a disc and a central rod while the seat is arranged on top of the central rod; the
balancing stand having a rack with a C-shaped rack symmetrical to a rotation axis while the shaft is set under the central point of the C-shaped rack while the tail end of two sides of the C-shaped rack forms a chair-shaped part and a concave is formed on two sides of the C-shaped rack for accommodation of the magnetic blocks; an umbrella cap is covered over the C-shaped rack with an azimuth scale disposed on surface thereof.

5. The compass ornament as claimed in claim 1, wherein the base having a frame and a decorative container while a transparent top cover is on top of the frame and the decorative container 16 is mounted horizontally inside the frame; the seat is arranged on top surface of the decorative container and the azimuth scale with a needle fixed thereof is disposed on the balancing stand.

6. The compass ornament as claimed in claim 5, wherein the decorative container is a transparent open-ended or close-ended container.

7. The compass ornament as claimed in claim 5, wherein the decorative container is disposed with liquid and ornaments therein.

8. The compass ornament as claimed in claim 1, wherein a plurality of light emitting diode is disposed on the bottom of the base.
